(19) United States
(12) Patent Application Publication
(10) Pub. No.: US 2008/0165376 A1
(43) Pub. Date: Jul. 10, 2008

(54) Image printing method and system

(75) Inventors: Junji Tomohiro, Nagano-ken (JP); Haruhiko Mochizuki, Matsumoto-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/978,001

(22) Filed: Oct. 25, 2007

(30) Foreign Application Priority Data
Oct. 27, 2006 (JP) 2006-292191

(51) Int. Cl. H04N 1/60

(52) U.S. Cl. 358/1.9

(57) ABSTRACT

There is provided an image printing method including obtaining an image, reducing a color area of the obtained image and generating a color area reduced image, extracting a contour from the obtained image and generating an outline image, generating a first image by overlapping the outline image with the color area reduced image, printing the first image on a recording medium, scanning an image containing an object recorded by a user on the recording medium on which the first image is printed, generating a second image by extracting the object recorded by the user based on the scanned image, and printing the second image on a recording medium.

The entire disclosure of Japanese Patent Application No. 2006-292191, filed Oct. 27, 2006 is expressly incorporated by reference herein.

### BACKGROUND

1. Technical Field

The present invention relates to an image printing method and an image printing system.

2. Related Art

Heretofore, there have been disclosed a technical method and a device for extracting an outline portion from an image such as a manuscript of a natural picture such as a photograph and an illustrated manuscript, subjecting a color reducing process to a predetermined color, a smoothing process, and the like, and outputting the natural picture as an image of illustration. For example, in the technical method described in JP-A-2002-185766 (hereinafter, referred to as Patent Document 1), a contour is extracted form a color image, a color name is added with a lead line when printing the contour as a monochrome image, and making it possible to utilize the printed paper for coloring. Further, in the technical method described in JP-A-10-74248 (hereinafter, referred to as Patent Document 2), each pixel of an input image is separated in accordance with one of attribute value of luminosity or saturation, color reducing is performed by using a lookup table, thereby forming an illustrate image in which feeling of an original image is remained while removing reality from the color image. Further, in the technical method described in JP-A-2002-222429 (hereinafter, referred to as Patent Document 3), an original image is displayed, an outline of each shape and a change portion of color of the original image is traced by the user by using a drawing tool such as a brush tool, thereby forming an image of a line drawing.

However, in the method for extracting a contour by the automatic process described in Patent Documents 1 and 2, in particular, when the original image is a natural picture such as a painting or a photograph, the obtained contour may be ambiguity or a needless contour not desired by the user may be obtained, so that it has been difficult to extract the image of only the portion of the contour desired by the user and in which the detail is appropriately omitted as an edge line. In order to solve these problems, improvement of the algorism for automatic edge extraction is required as a matter of course, detail setting such as setting of the level of edge extraction, setting of an area having a complex shape which is not only a rectangle shape may be required. Further, in the technical method described in Patent Document 3, mastership of the operation technique of drawing tools or the like is required for the user to execute, and the operation is not so easy for anyone.

### SUMMARY

An advantage of some aspects of the invention is that it provides an image forming system, an image forming method, an image forming program, and a recording medium which make it possible to obtain an image of, for example, a line drawing such as a contour desired by the user from a natural picture such as a painting or a photograph without requiring a complicated image processing and techniques operated by the user.

According to an aspect of the invention, there is provided an image forming system equipped with an image obtaining portion for obtaining an image, a first image generating portion for generating a first image by reducing a color area of the obtained image, a first printing portion for printing the first image on a recording medium, a scanning portion for scanning an image containing an object recorded by a user on the recording medium on which the first image is printed, a second image forming portion for generating a second image by extracting the object recorded by the user based on the scanned image, and a second printing portion for printing the second image on a recording medium.

According to the aspect of the invention, an image is obtained by an image obtaining portion, a first image is generated by reducing a color area of the obtained image by a first image generating portion, and the generated first image is printed on a recording material by a first printing portion. Then, an image containing an object recorded by a user on the first image is scanned by a scanning portion, a second image is generated by extracting the object recorded by the user based on the scanned image, and the generated second image is printed on a recording medium by the second printing portion. An object is added to a first image printed on a recording medium by the user, so that the user can add a predetermined object, for example, such as a contour or the like of an image by referring the content of the first image. Further, the first image is an image whose color area is reduced, so that the object can be easily and precisely extracted from the scanned image containing the object scanned by the scanning portion when the object is added by a color except the color reduced by the user. The object extracted here is an object desired by the user, and there is no inconvenience in that, for example, a necessary contour is missing or a needless contour or the like is contained. Herewith, the user can obtain a desired image of a line drawing, for example, such as a contour from a natural picture such as a painting or a photograph without requiring a complicated image processing or techniques operated by the user.

It is preferable that the first image generating portion generates the first image mainly expressed by one hue in the image forming system.

Further, it is preferable that the first image generating portion generates the first image reduced in shade in the image forming system.

Further, it is preferable that an image recording portion for recording image data expressing the generated second image is further included in the image forming system.

Further, it is preferable that the image recording portion records vector data generated by vectorizing the image data expressing the generated second image in the image forming system.

Further, it is preferable that an outline image generating portion for generating an outline image by extracting a contour from the obtained image is further included and the first image generating portion generate the first image by overlapping the generated outline image with the color area reduced image in the image forming system.

Further, it is preferable that the outline image generating portion generates the outline image having the hue and the saturation which are respectively approximately the same as the average of the hue of the color area reduced image and the average of the saturation of the color area reduced image in the image forming system.

Further, it is preferable that the outline image generating portion generates the outline image having the luminosity lower than the average luminosity of the color area reduced image in the image forming system.

Further, it is preferable that an operating portion for receiving an operation form the user is further included and the operating portion receives an instruction for printing the image selected from among the outline image, the color area reduced image, and the overlapped image of the color area reduced image and the outline image in the image forming system.

Further, it is preferable that a display portion for displaying the generated outline image is further included and the operating portion receives the selection of whether the outline image is printed on the recording medium or not is made in the state where the outline image is displayed on the display portion in the image forming system.

Further, it is preferable that the operating portion receives an instruction for starting of reading out of the scanned image in a row after printing the color area reduced image or the overlapped image of the color area reduced image and the generated outline image on the recording medium in the image forming system.

According to another aspect of the invention, there is provided an image forming method including obtaining an image, generating a first image by reducing color area of the obtained image, printing the first image on a recording medium, scanning an image containing an object recorded by a user on the recording medium on which the first image is formed, generating a second image by extracting the object recorded by the user based on the scanned image, and printing the second image on a recording medium.

According to another aspect of the invention, there is provided an image forming program equipped with an image obtaining function for obtaining an image, an image generating function for generating a first image by reducing a color area of the obtained image, a first printing function for printing the first image on a recording medium, a scanning function for scanning an image containing an object recorded by the user on the recording medium on which the first image is formed, a second image generating function for generating a second image by extracting the object recorded by the user based on the scanned image, and a second printing function for printing the second image on a recording medium.

According to another aspect of the invention, there is provided a recording medium which is a recording medium in which the image forming program is recorded so as to be read out by a computer.

### BRIEF DESCRIPTION OF THE DRAWINGS

The invention will be described with reference to the accompanying drawings, wherein like numbers reference like elements.

FIG. 1 is a diagram showing an appearance of a multifunction machine.

FIG. 2 is a block diagram showing a structure of the multifunction machine.

FIGS. 3A and 3B is a flow chart showing a whole process of coloring printing.

FIG. 4 is a flow chart showing a process for generating a background image.

FIG. 5 is a diagram schematically showing a color area of a full color image and a color area of a background image.

FIGS. 6A to 6E are each a diagram showing an example of change in gray scale property in the process till a background image is generated. FIG. 6A is a histogram showing gray scale property of a user image. FIG. 6B is a histogram showing gray scale property after converted to a gray tone image. FIG. 6C is a histogram showing gray scale property after correction. FIG. 6D is a histogram showing gray scale property of a mono tone image of cyan. FIG. 6E is a histogram showing gray scale property after compressed to a highlight band.

FIGS. 7A to 7C are each a drawing showing an example of a tone curve for converting an image. FIG. 7A is a tone curve for converting to a monotone image of cyan. FIG. 7B is a tone curve for compressing a highlight band. FIG. 7C is a tone curve for correcting a highlight grayscale.

FIG. 8 is a flow chart showing a process for generating an outline image.

FIGS. 9A and 9B are each a diagram showing an example of change in gray scale property in the process till an outline image is generated. FIG. 9A is a histogram showing gray scale property after converting to a gray tone image. FIG. 9B is a histogram after correcting a part of a highlight gray scale.

FIG. 10 is a flow chart showing a printing process of a trace sheet.

FIG. 11 is a diagram showing an example of a trace sheet image.

FIG. 12 is a flow chart showing a detail of a process for generating a handwritten outline image.

FIG. 13 is a graph showing an example of data stored in a color area table of a background image.

FIG. 14 is a flow chart showing a process for generating a color area table of a background image.

FIG. 15 is a flow chart showing a process for removing a background image.

FIGS. 16A to 16D are each a diagram showing an example of an operation screen. FIG. 16A shows a selection screen for input method. FIG. 16B is a reception screen for image selection. FIG. 16C is an instruction screen for requiring setting of a manuscript. FIG. 16D is an instruction screen for requiring setting of a trace sheet.

FIGS. 17A to 17D are each a diagram showing an example of the operation screen. FIG. 17A is a reception screen for receiving various selections after displaying a user image. FIG. 17B is a reception screen for trimming. FIG. 17C is a reception screen for receiving various selections after displaying an outline image. FIG. 17D is a reception screen for storing a coloring sheet image.

FIGS. 18A to 18D are each a diagram showing an example of an image in each process till a coloring sheet is printed. FIG. 18A is a diagram showing an obtained user image. FIG. 18B is a diagram showing a background image printed on a trace sheet. FIG. 18C is a diagram showing an image obtained by scanning the background image containing a handwritten outline image. FIG. 18D is a diagram showing a handwritten outline image printed on a coloring sheet.

FIGS. 19A to 19B are each a diagram showing an image in each process till a coloring sheet is printed. FIG. 19A is a diagram showing an outline image automatically generated. FIG. 19B is a diagram showing an image in which an outline image is combined with a background image.

### DESCRIPTION OF EXEMPLARY EMBODIMENTS

Hereinafter, an embodiment of an image forming system according to the invention will be described with reference to accompanying drawings.

### Structure of Image Forming System Multifunction

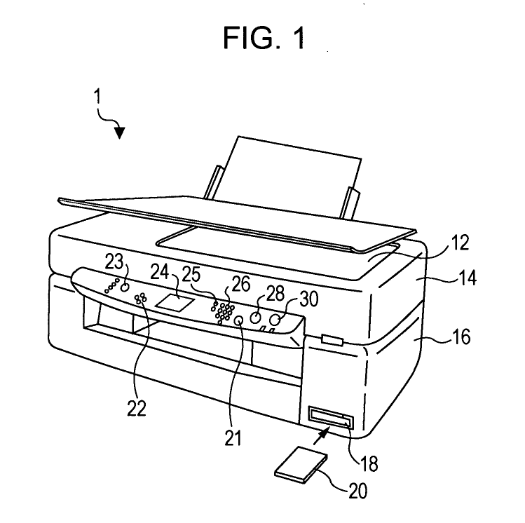

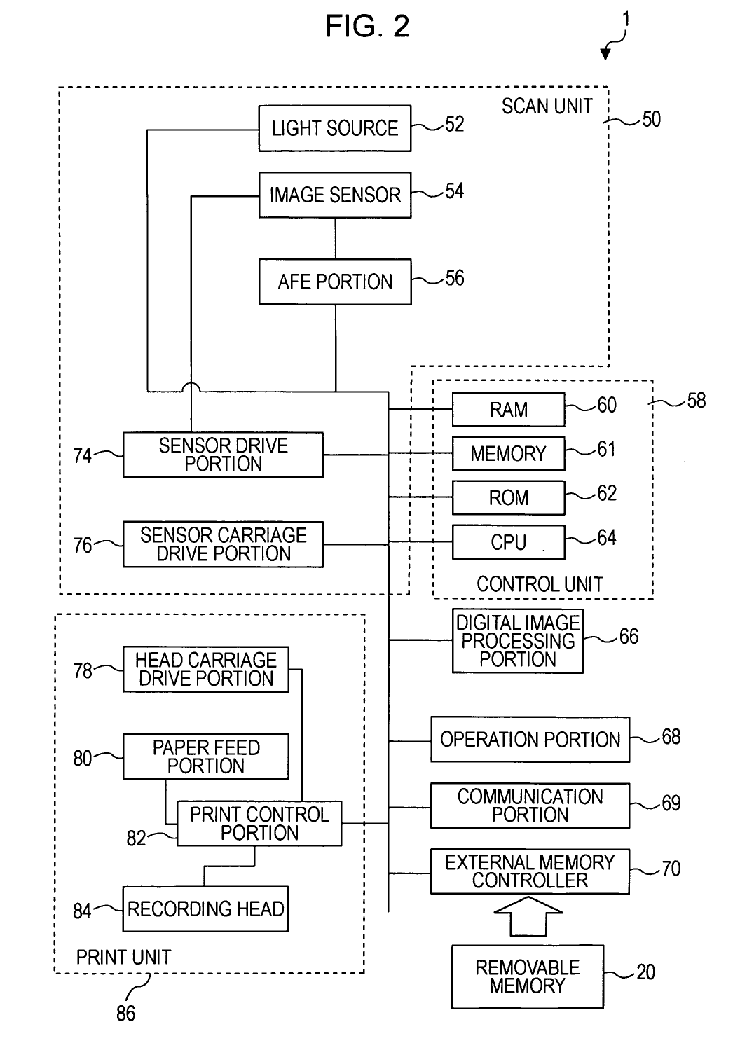

First, a hardware structure of a multifunction machine 1 as an image forming system according to the invention will be described. FIG. 1 is a diagram showing an appearance of a multifunction machine. FIG. 2 is a block diagram showing a structure of the multifunction machine. The multifunction machine 1 has a printing function of an image input from a removable memory 20 such as a memory card or a PC (Personal Computer) not shown and a copying function. It should be noted here that the image forming system according to the invention may be constituted by a scanner having image reading function, a printer having printing function, and a PC having a function for controlling the scanner and the printer.

As shown in FIG. 2, the multifunction machine 1 is constituted by a scan unit 50, a control unit 58, a print unit 86, and the like. The scan unit 50 is housed in an upper case 14 shown in FIG. 1 and equipped with a light source 52, an image sensor 54, an AFE (Analog Front End) portion 56, a sensor drive portion 74, a sensor carriage drive portion 76, and the like. The light source 52 consists of a fluorescent lamp or the like that is long in a main scanning direction. The image sensor 54, which is driven by the sensor drive portion 74, is a liner image sensor such as a color CCD liner image sensor equipped with a group of RGB 3-channel photoelectric elements. Further, the image sensor 54 is mounted on a sensor carriage not shown which moves parallel to a transparent manuscript table 12 shown in FIG. 1. The image sensor 54 outputs an electrical signal correlating with light and shade of an optical image of a manuscript imaged on the acceptance surface by a lens and a mirror not shown. The sensor carriage drive portion 76 is equipped with a motor, a driving belt, a driving circuit, and the like not shown. The sensor carriage drive portion 76 moves the sensor carriage back and forth along a guide rod not shown mounted perpendicular to a main scanning direction. Herewith, the image sensor 54 enables to scan a two-dimensional image by moving in a direction perpendicular to the main scanning direction. The AFE portion 56 is equipped with an analog signal processing circuit, an A/D converter, and the like for performing amplification, removing noise, and the like.

The print unit 86 is housed in a lower case 16 shown in FIG. 1 and equipped with a recording head 84 for forming image on a paper with an ink jet system, a head carriage drive portion 78, a paper feed portion 80, a print control portion 82 for controlling these parts, and the like. Note that the print unit 86 may alternatively be of a construction corresponding to some other printing method such as a laser system. The recording head 84 is provided on a head carriage not shown on which an ink cartridge is mounted and equipped with a nozzle, a piezoelectric device, a piezoelectric driving circuit for outputting a driving signal applied to the piezoelectric device, and the like. The piezoelectric driving circuit can control the size of an ink drop ejected from the nozzle to three levels of large, middle, and small by a waveform of a driving signal applied to the piezoelectric device. The piezoelectric driving circuit applies a driving signal having a predetermined waveform to the piezoelectric device in accordance with a control signal output from the print control portion 82. The head carriage drive portion 78 is equipped with a motor, a driving belt, a motor driving circuit, and the like not shown and moves the recording head 84 back and forth in the direction perpendicular to the feed direction of a paper. The paper feed portion 80 is equipped with paper feed rollers, a motor, a motor driving circuit, and the like not shown and feeds a paper in the direction perpendicular to an axis line of a moving direction of the recording head 84 by rotating the paper feed rollers. The print control portion 82 is an ASIC equipped with a buffer memory to which printing data is sequentially transferred from a RAM 60 described below, and has a function for controlling a timing for outputting printing data stored in a buffer memory to the recording head 84 in accordance with a position of the head carriage, a function for controlling the carriage drive portion 78, and a function for controlling the paper feed portion 80.

An external memory controller 70 is connected to the removable memory 20 inserted from a card slot 18 shown in FIG. 1 and functions as an access unit. The data stored in the removable memory 20 is read out by the external memory controller 70 and transferred to the RAM 60. The operating portion 68 is equipped with an LCD 24 as a display unit portion for displaying menus and images, and with various push buttons for operating menus such as a return button 21, a cross-shape button 22, a DISP button 23, +− button 25, a numeric keypad 26, an OK button 28, a printing start button 30. Note that the operating portion 68 may be constituted by a touch panel, a pointing device, and the like. A communication portion 69 is a communication interface which makes the control unit 58 to communicate with an external system and functions as an access unit. Further, the communication portion 69 communicates with an external system via a LAN, Internet, an USB, or the like.

The control unit 58 is equipped with the RAM 60, a memory 61 as an image recording portion, a ROM 62, a CPU 64, and the like. The CPU 64 executes a control program stored in the ROM 62 and controls each portion of the multifunction machine 1. The ROM 62 is a nonvolatile memory storing a control program or the like. The RAM 60 is a volatile memory in which an image obtained from the removable memory 20 or the like, an image scanned by the scan unit 50, various image data used in the generation process of a back ground image and an outline image, and the like are temporally stored. The memory 61 is a nonvolatile memory for storing image data and the like that expressing an outline image and the like printed on a coloring sheet. The control program may be stored in the ROM 62 from an outmost saver via a network or may be stored in the ROM 62 via a recording medium such as the removable memory 20 which can be read out by a computer. A digital image processing portion 66 is a dedicated circuit of a DSP or the like for executing image process such as decoding of JPEG image, resolution conversion, unsharp process, gray scale correction, dividing of gray scale into two scales, and separate process in cooperation with the CPU 64.

### Whole Process of Coloring Print

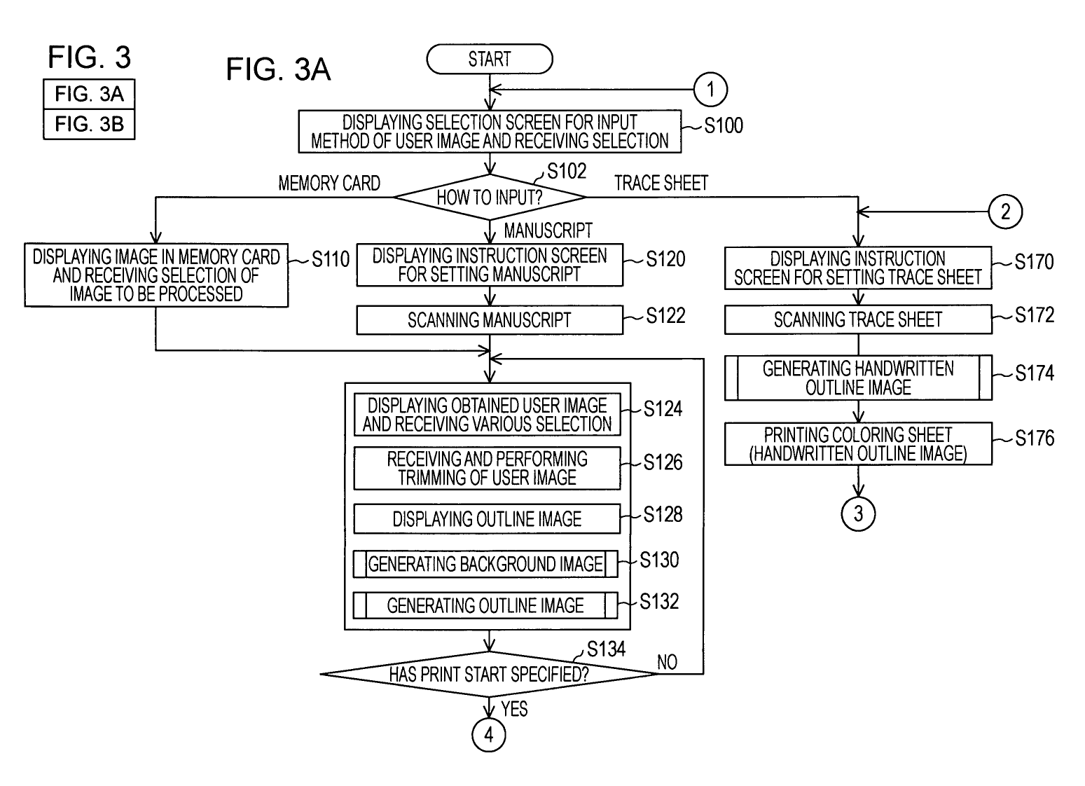

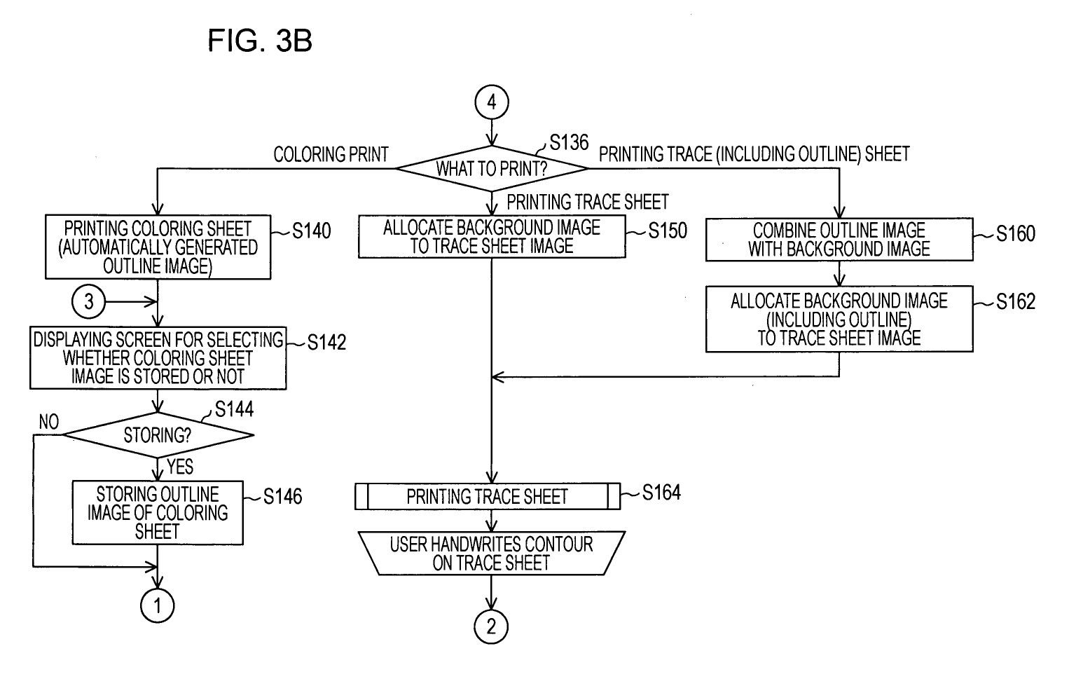

Next, a sequence of processes from obtaining a user image to printing a coloring sheet will be described. FIGS. 3A and 3B is a flow chart showing the whole process of coloring print. Each step shown in FIGS. 3A and 3B is performed by the control unit 58. Herein, the coloring sheet in FIGS. 3A and 3B is a paper on which a line drawing or the like used for coloring by the user is printed. Further, a trace sheet is a paper used for preparing a coloring sheet, and a background image to be a basis of coloring is printed on the trace sheet as a trace. The user directly handwrites a contour or the like to be a line drawing used for coloring on a trace sheet based on the background image.

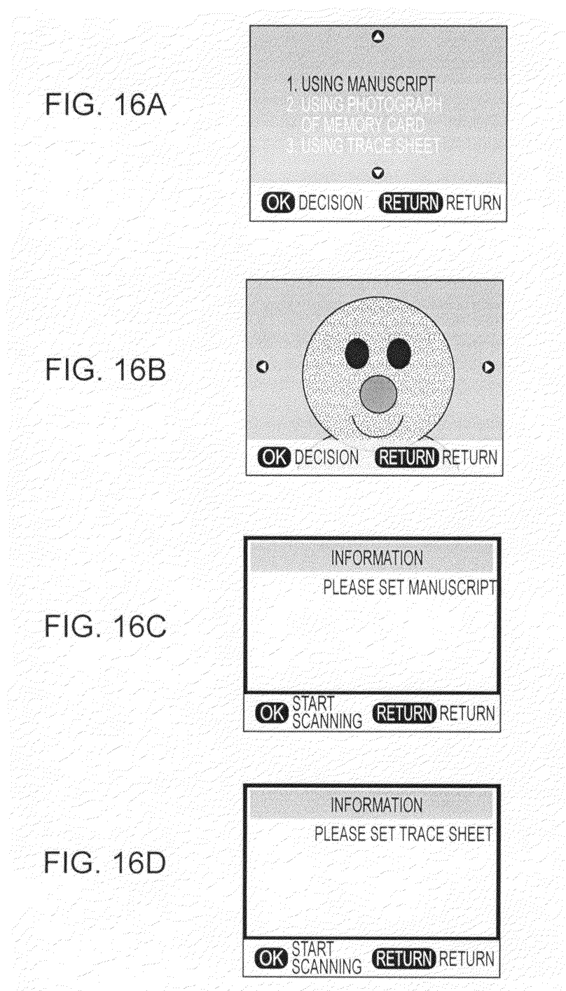

First, in step S100, the control unit 58 displays a selection screen for input method of a user image to be an original image and receives a selection of input method from the user via the operating portion 68. FIGS. 16A to 16D are each a diagram showing an example of an operation screen and FIG. 16A is a selection screen for input method. Herein, as input methods, three types of input methods of “using manuscript”, “using photograph of memory card”, and “using trace sheet” are displayed for receiving the selection. When the user selects the input method and pushes the OK button 28 shown in FIG. 1, the process proceeds to step S102 and the selected input method is judged. On the other hand, when the return button 21 is pushed, the process for coloring print is finished. Note that a brunch line showing the flow when the return button 21 is pushed is omitted in the flow chart shown in FIGS. 3A and 3B.

In step 102, the control unit 58 judges the input method selected in step S100. When the input method is “using manuscript”, the process proceeds to step S120, when “using photograph of memory card”, the process proceeds to step 110, and when “using coloring sheet”, the process proceeds to step 170.

In step S110, the control unit 58 displays images stored in a memory card and receives selection of an image to be processed from now on from the user via the operating portion 68. FIG. 16B is a reception screen for image selection. Herein, the user selects an image by operating the cross-shape button 22. When the OK button 28 is pushed, the process proceeds to step S124 for receiving various selection. On the other hand, when the return button 21 is pushed, the process returns to the selection screen for input method shown in FIG. 16A in step S100.

In step S120, the control unit 58 displays an instruction screen for requiring the user to set a manuscript to be a user image on the manuscript table 12. FIG. 16C is an instruction screen for requiring setting of a manuscript. When the user sets a manuscript and pushes the OK button 28, the process proceeds to step S122 and scanning operation of the manuscript is started by the scan unit 50. The process proceeds to step S124 after finishing the scanning operation. On the other hand, when the return button 21 is pushed, the process returns to step S100 and the selection screen for input method of FIG. 16A is shown.

In steps S124, S126, S128, S130, and S132, the control unit 58 performs displaying of the user image obtained in step S110 or S122, receiving and executing a trimming process on the user image, displaying an outline image automatically generated from the user image, and the like. Further, the control unit 58 receives shifting to each screen and various selections from the user via the operating portion 68.

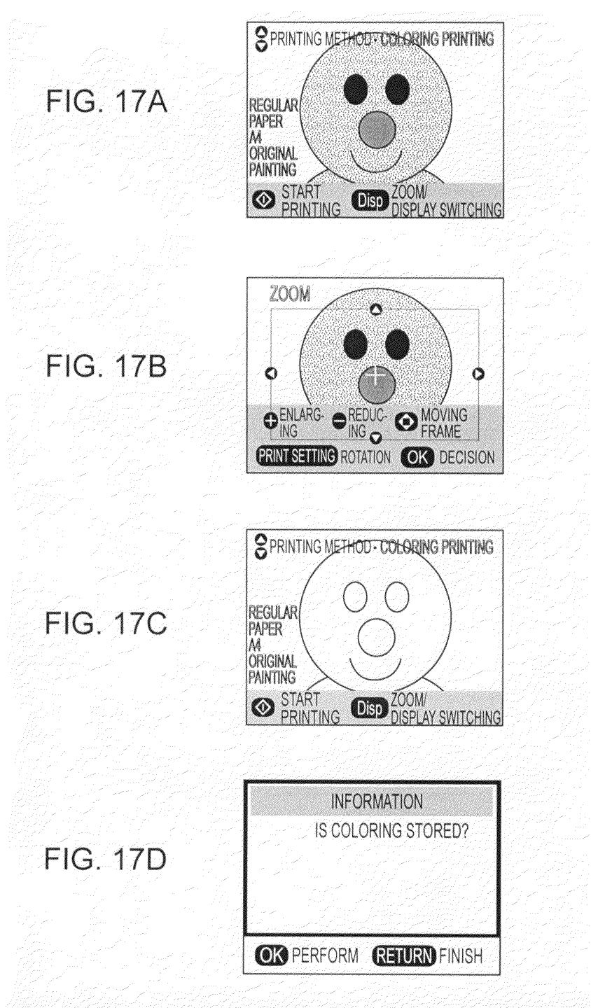

FIGS. 17A to 17D are each a diagram showing an example of the operation screen, and FIG. 17A is a reception screen for receiving various selections after displaying a user image and is displayed in step S124. With the screen, the user selects printing method by operating the cross-shape button 22 and shifts to the reception screen for trimming or display screen of an outline image by pushing the DISP button 23. In addition, printing is started by the selected printing method by pushing the printing start button 30. On the other hand, when the return button 21 is pushed, the screen returns to the screen for obtaining a user image shown in FIG. 16B is step S110 or shown in FIG. 16C in step S120. Herein, as for the types of the printing method selected by the user, three types of “coloring print”, “trace sheet print”, and “trace (including outline) sheet print” exist.

FIG. 17B is a reception screen for trimming and is displayed in step S126. Processes for enlarging, reducing, frame moving, rotation, and the like of a user image are received from the user by operating the cross-shape button 22, the +− button 25, the printing start button 30, and the like. In addition, by pushing the DISP button 23, the screen is shifted to a display screen of an outline image. Further, by pushing the printing start button 30, printing is started by selected printing method. On the other hand, when the return button 21 is pushed, the screen returns to the screen for obtaining a user image as shown in FIG. 16B in step S110 or FIG. 16C in step S120.

FIG. 17C shows a reception screen for receiving various selections after displaying an outline image and is displayed in step S128. In the screen, the user selects recording method by operating the cross-shape button 22 and shifts the screen to a display screen of the user image or a reception screen for trimming by pushing the DISP button 23. Further, by pushing printing start button 30, printing is started by the selected recording method. On the other hand, when the return button 22 is pushed, the screen returns to the screen for obtaining a user image shown in FIG. 16B in step S110 or shown in FIG. 16C in step S120.

In step S130, a back ground image which becomes a trace recorded on a trace sheet is generated based on the user image displayed in the above described step S124 or the user image subjected to a trimming process in step S126. Further, in step S132, an outline image displayed in step S128 is generated based on the background image. Note that the details of the generation process of the background image and the generation process of the outline image will be described below.

In step S134, the control unit 58 waits until the printing start button 30 for specifying printing start is pushed in step S124, S126, or S128. When the printing start button 30 is pushed, the process proceeds to the next step S136. In step S136, the control unit 58 judges the printing method selected by the user in steps S124 and S128. When the selected printing method is “coloring print”, the process proceeds to step S140, when “trace sheet print”, the process proceeds to step S150, and when “trace (including outline) sheet print”, the process proceeds to step S160.

In step S140, the control section 58 allocates the (automatically generated) outline image displayed in step S128 to a coloring sheet for printing. The user can perform coloring by referring the outline image printed on the coloring sheet as a line drawing.

In step S142, the control unit 58 receives the selection of whether the image of the coloring sheet printed in step S140 is stored or not from the user via the operating portion 68. FIG. 17D is a reception screen for storing a coloring sheet image.

When storing or not is judged in step S144 and the OK button 28 is pushed by the user, the image data expressing the outline image printed on the coloring sheet is recorded and stored in the memory 61. Then, the process returns to the initial step S100 and the selection screen for input method shown in FIG. 16A is displayed. On the other hand, when the return button 21 is pushed, no image data is stored and the process returns to step S100.

In step 150, the control unit 58 allocates the background image generated in step S130 to a trace sheet image, and the process goes to printing of the trace sheet in step S164.

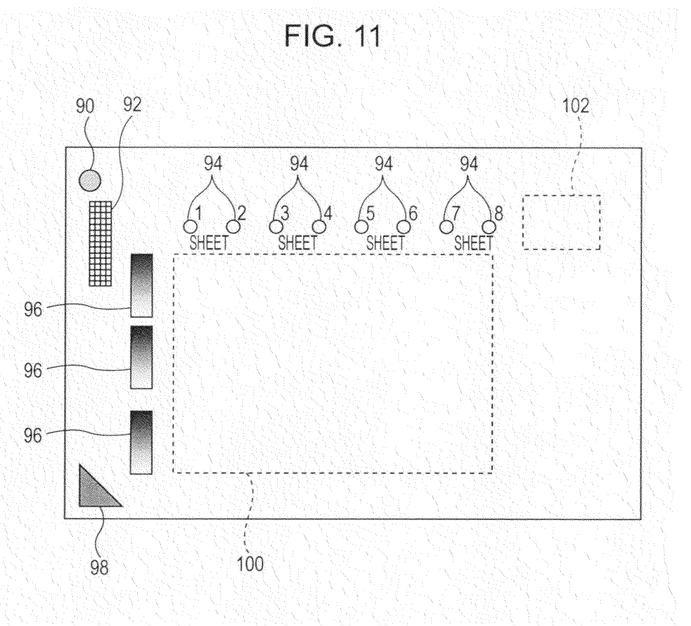

FIG. 11 is a diagram showing an example of a trace sheet image. The trace sheet image is stored in the ROM 62 as one image as the whole or a combination of drawing command of image parts. Each of position standard marks 90 and 98 is a mark which enables the control unit 58 to recognize the position and inclination of the trace sheet mounted on the manuscript table 12. A block code 92 is a mark which enables the control unit 58 to recognize the type of the trace sheet. Each of a plurality of check marks 94 is a mark which enables the control unit 58 to recognize the number to be printed. Each of a plurality of sample patches 96 is a chart whose color area is equivalent to that of the background image and whose density is uniformly converted. The number of the sample patches 96 may be one and may be constituted by a plurality of areas having a different color area for each other. Peak coordinates facing with each other of a rectangular free drawing area 100 are recorded in the ROM 62. The rectangular free drawing area 100 is an area to which a background image is allocated. Peak coordinates facing with each other of a sub image area 102 are recorded in the ROM 62. An obtained user image is allocated to the sub image area 102 at the gray scale property without modification. The user image allocated in the sub image area 102 may be an image having the maximum resolution and may be a thumbnail image.

In step S160, the control unit 58 combines the outline image generated in step S132 with the background image generated in step S130. Herein, the control unit 58 overlaps the outline image with the background image for combination by adding a color value of the background image to a color value of the outline image for every RGB channel.

In step S162, the control unit 58 allocates the background image (including outline) to which the outline image is combined to a trace sheet image. Herein, the background image (including outline) is allocated to the free drawing area 100 of the trace sheet image shown in FIG. 11.

In step S164, the control unit 58 prints the trace sheet image to which the background image or the background image (including outline) is allocated in step S150 or step S162. Then, the process proceeds to step S170 and an instruction screen for requiring the user to set a trance sheet is displayed. Note that the process of printing the trace sheet will be described below in detail.

After the trace sheet is printed, the user handwrites a contour or the like which becomes a line drawing for coloring on the background image by referring the background image printed on the trace sheet as a trace. In addition, the user can print a plurality of coloring sheet by checking the check mark 94 which is positioned so as to correspond to the desired print number of the trace sheet by handwriting.

In step S170, the control unit 58 displays an instruction screen for requiring the user to set the trace sheet on the manuscript table 12. FIG. 16D is an instruction screen for requiring setting of the trace sheet. When the user sets the trace sheet and pushes the OK button 28, the process proceeds to step S172 and the scan unit 50 starts scanning operation of the trace sheet. By the scanning operation, the background image containing a handwritten outline image as an object recorded by the user is obtained. On the other hand, when the return button 21 is pushed, the screen returns to the selection screen of input method shown in FIG. 16A in step S100.

In step S174, the control section 58 generates a handwritten outline image to be printed on a coloring sheet as a line drawing from the background image containing the handwritten outline image obtained in step S172. Herein, the handwritten outline image is generated by separating the image of the contour or the like which is handwritten on the background image printed on the free drawing area 100 of the trace sheet by the user from the background image for extraction. Note that the detail of the process for generating the handwritten outline image will be described below.

In step S176, the control unit 58 allocates the handwritten outline image generated in step S174 to a coloring sheet for printing. The user can perform coloring by referring the handwritten outline image printed on the coloring sheet as a line drawing. After printing, the process proceeds to step S142 and the selection of whether the outline image of the coloring sheet is stored or not is received.

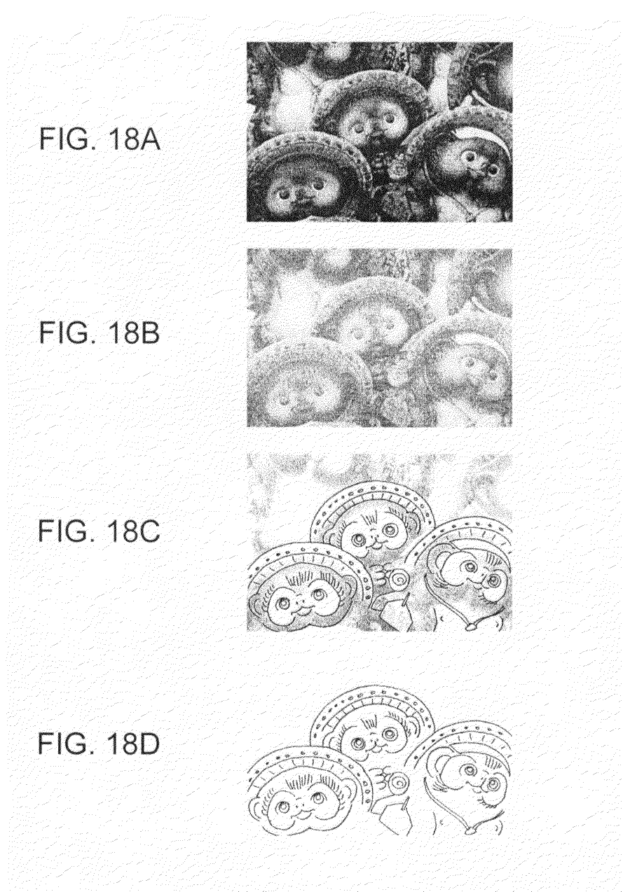

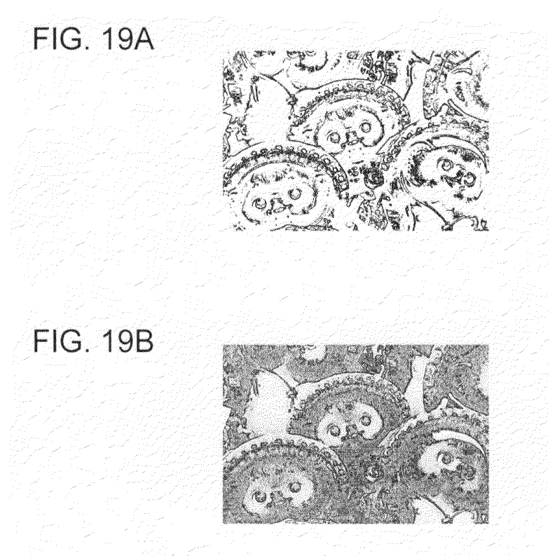

FIGS. 18A to 18D and FIGS. 19A to 19B are each a diagram showing an example of an image in each process till a coloring sheet is printed. FIG. 18A is a diagram showing an obtained user image. FIG. 18A becomes an image obtained in the above step S110 or step S122. FIG. 18B is a diagram showing a background image printed on the trace sheet. FIG. 18B becomes an image of a background image generated in step S130 based on the user image shown in FIG. 18A and printed on a trace sheet without modification in step S164. FIG. 18C is a diagram showing an image obtained by scanning a background image containing a handwritten outline image. FIG. 18C becomes an image obtained by scanning the trace sheet on which a contour is handwritten on the background image shown in FIG. 18B by the user in step S172. FIG. 18D is a diagram showing a handwritten outline image printed on a coloring sheet. FIG. 18D becomes an image of a handwritten outline image extracted form the background image containing the handwritten outline image shown in FIG. 18C in step S174 and printed on a coloring sheet as a line drawing for coloring in step S176.

Further, FIG. 19A is a diagram showing an automatically generated outline image. FIG. 19A becomes an image of the outline image generated based on the background image shown in FIG. 18B in step S132 and printed on a coloring sheet as a line drawing for coloring in step S140. FIG. 19B is a diagram showing an image in which the outline image is combined with the background image. FIG. 19B becomes an image combined in step S160 by combining the outline image shown in FIG. 19A with the background image shown in FIG. 18B and printed on a trace sheet in step S164.

Note that the first image of the invention corresponds to a background image allocated to a trace sheet image in the above step S150 or a background image (including outline) allocated to a trace sheet image in the above step S162. Further, the second image of the invention corresponds to a background image containing a handwritten outline image obtained in the above step S172. Further, the third image of the invention corresponds to a handwritten outline image generated in the above step S174.

Further, the image obtaining portion, the image obtaining process, and the image obtaining function of the invention correspond to the above steps S110 and S122. Further, the first image generating portion, the first image generating process, and the first image generation function of the invention correspond to the above steps S130 and S160. Further, the first image forming portion, the first image forming process, and the first image forming function correspond to the above step S164. Further, the scanning portion, the scanning process, and the scanning function of the invention correspond to the above step S172. Further, the third image generating portion, the third image generating process, and the third image forming function of the invention correspond to the above step S174. Further, the third image generating portion, the third image generating process, and the third image forming function of the invention correspond to the above step S176. Further, the outline image generating portion of the invention corresponds to the above step S132.

### Process for Generating Background Image

Next, a process for generating a background image will be described in detail.

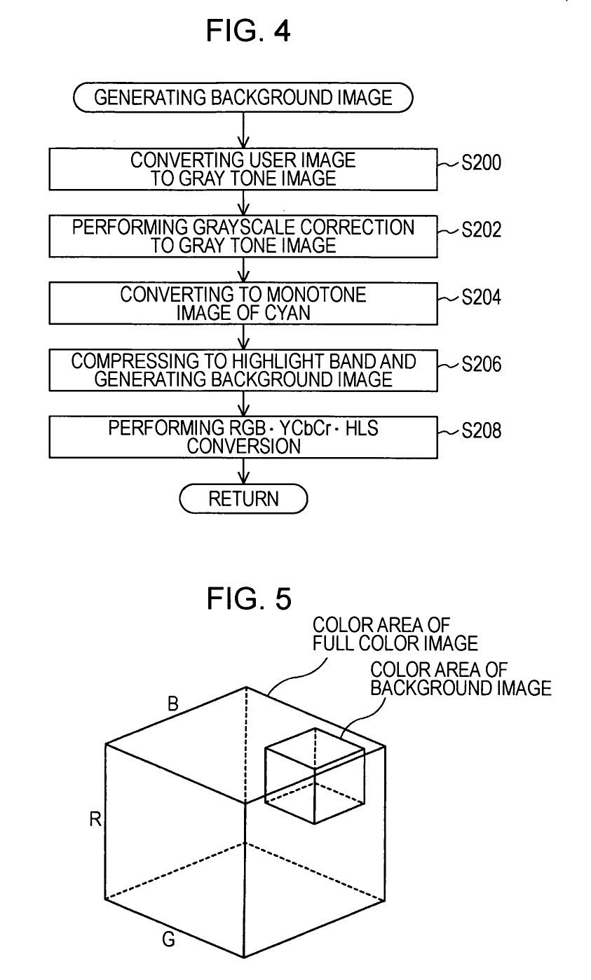

FIG. 4 is a flow chart showing a process for generating a background image. The control unit 58 generates a background image based on a user image in combination with a digital image processing portion 66 in each step shown in FIG. 4. The user image may be an image having the maximum resolution or may be a thumbnail image. When a background image is formed based on a thumbnail image, there is an advantage in that the processing time is reduced. A user image having JPEG format or the like has three color channels of RGB when decoded and the color area of the user image is constituted by color values of 16777216 (256×256×256) when the gray scale value of each channel is constituted by 1 byte. Herein, when the color area of the user image spreads to the whole color space, it is extremely difficult to optically recognize the character area written on a printed user image by a color pen or the like. On the contrary, when the color area of the user image and the color area of the character area are not overlapped, the pixels of a particular color area can be judged as a character area. That is, in order to expand a color area of an object such as a character which can be written on the user image, that is, in order to increase the type of the color with which the user can write, the color area of the user image to be a background image has to be narrowed.

First, in step S200, the control unit 58 convert a user image to a gray tone image. FIG. 5 is a diagram specifically showing a color area of a full color image and a color area of the background image. As any object is expressed by the user image, the color area of the user image becomes the color area of the full color (for example, 16777216 colors) image. Herein, in order to narrow the color area of the background image printed on a trace sheet as shown in FIG. 5, the user image is converted to a gray tone image.

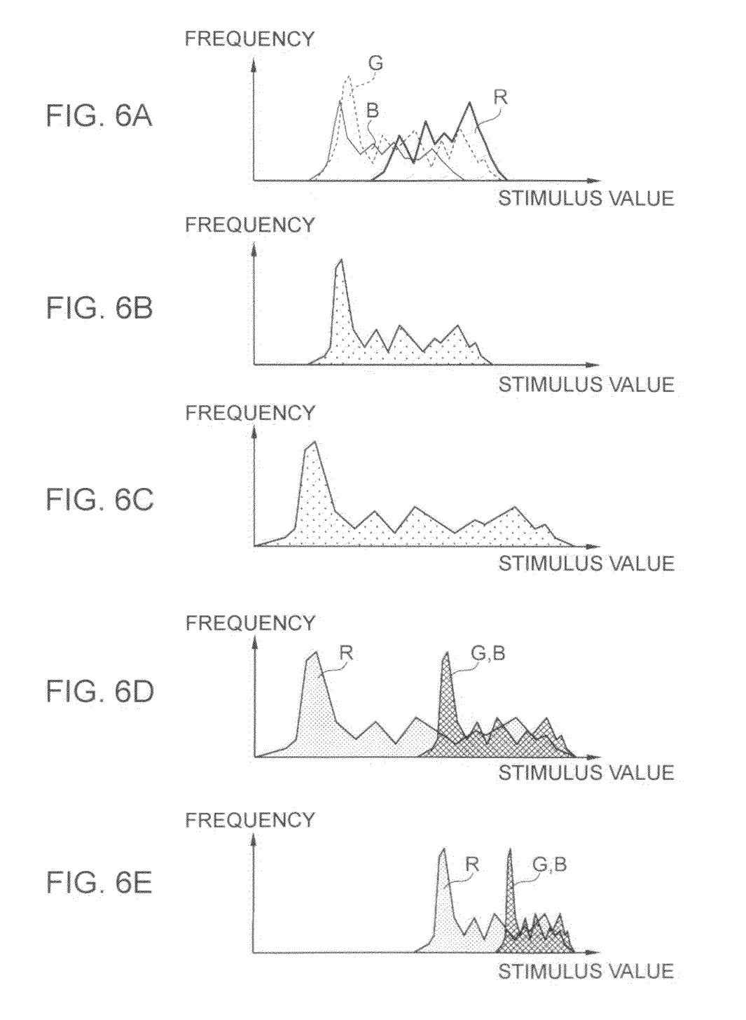

Further, FIGS. 6A to 6E are each a diagram showing an example of the change in gray scale property in the process till a background image is generated. FIG. 6A is a histogram showing a gray scale property of a user image. FIG. 6B is a histogram showing a gray scale property after converted to a gray tone image. When the user image having the gray scale property shown in FIG. 16A is converted to the gray tone image, the gray scale property of the gray tone image becomes coincident with each other in the histogram of each RGB channel as shown in FIG. 6B. Herein, the control unit 58 converts a user image to a gray tone image by using a luminosity conversion equation of an NTSC system described below.

R′=G′=B′=0.299×R+0.587×G+0.114×B

Further, the control unit 58 may obtain the luminosity from RGB and convert the gray scale value of RGB to the value having a linear relation to the luminosity to generate a gray tone image, or may generate a gray tone image by converting the gray scale value of R channel and B channel to the gray scale value of G channel.

In step S202, the control unit 58 performs gray scale correction to the gray tone image generated in step S200. The gray scale correction is a correction for emphasizing color tone or contrast automatically performed by using a common method. FIG. 6C is a histogram showing gray scale property after correction. As shown in FIG. 6C, the dynamic range of the histogram expressing the range of the distribution of the gray tone portion in the image is expanded after the gray scale correction.

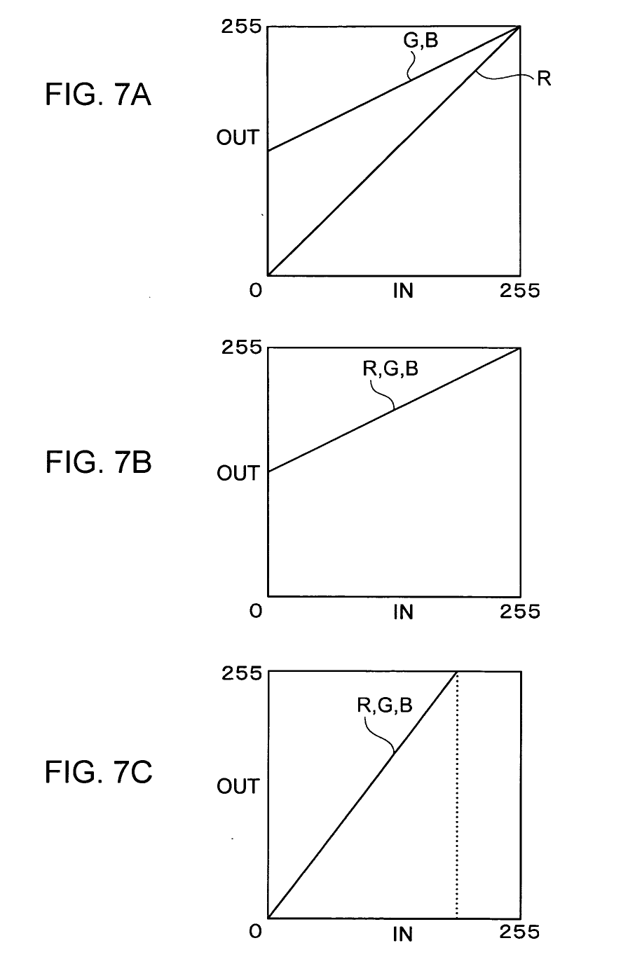

In step S204, the control unit 58 converts the gray tone image subjected to the gray scale correction in step S202 to a monotone image of cyan. FIGS. 7A to 7C are each a diagram showing an example of a tone curve for converting an image. FIG. 7A is a tone curve for converting to a monotone image of cyan. The gray tone image subjected to gray scale correction is converted in accordance with the tone curve shown in FIG. 7A to generate a monotone image of cyan. FIG. 6D is a histogram showing gray scale property of a monotone image of cyan. As shown in FIG. 6D, after converted to a monotone image of cyan, the gray scale of R channel becomes the main and the gray scale property becomes of cyan gray scale property in which gray scale is also added to G and B channels in some degree. By the presence of the gray scale also in G and B channels, the visibility of the background image is increased and the user can easily trace an outline portion or the like of an image in handwriting.

In the embodiment, the description is made for the case where an image is converted to a monotone image of cyan in which the gray scale of R channel is the main. However, note that the monotone image is not limited to R channel and cyan.

In step S206, the control unit 58 compresses the gray scale value of the monotone image of cyan generated in step S204 to a highlight band to generate a background image. FIG. 7B is a tone curve for compressing to a highlight band. The gray scale value of a monotone image of cyan are converted in accordance with the tone curve shown in FIG. 7B to compress to a highlight band. FIG. 6E is a histogram showing gray scale property after compressed to a highlight band. A background image generated by compressing to a highlight band has the gray scale property shown in FIG. 6E and the image becomes light as compared with the original user image.

In step S208, the control unit 58 performs conversion of RGB, YCbCr, and HLS to the background image generated in step S206. The conversion is performed for treating the values of the hue (H), luminosity (L), and saturation (S) of the background image in the device and for setting the H, L, and S of an outline image based on the H, L, and S of a background image when generating the outline image described below. Herein, the known conversion equation such as, for example, JFIF standard or sYCC standard is used for the conversion between RGB and YCbCr.

Saturation S=\sqrt{Cb²+Cr²}

Luminosity L=Y

Hue H=tan⁻¹(Cr/Cb) Equation 1

On the other hand, when H and S are provided, Cb and Cr can be obtained, for example, by the equations described below.

Cr=S sin H

Cb=S cos H

Note that the conversion between RGB, YCbCr, and HLS may be performed by using another method except the method using the equations descried above.

### Process for Generating Outline Image

Next, a process for generating an outline image will be described in detail.

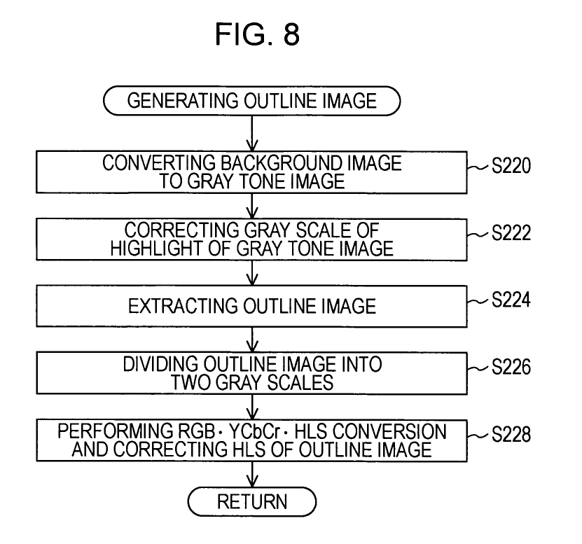

FIG. 8 is a flow chart showing a process for generating an outline image. The control unit 58 generates an outline image in cooperation with the digital image processing portion 66 in each step shown in FIG. 8. Further, the outline image is generated based on a background image generated in the above described step S206 shown in FIG. 4.

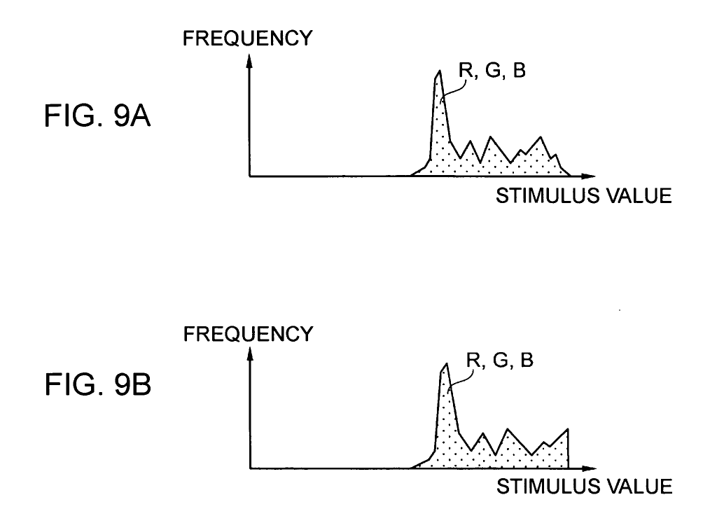

First, in step S220, the control unit 58 converts a background image to a gray tone image again. The gray scale value of the monotone image of cyan is compressed to a highlight band in the background image and the background image is converted to a gray tone image by applying the image of R channel also to G and B channels. FIGS. 9A and 9B are each a diagram showing an example of the change in gray scale property in the process till an outline image is generated. FIG. 9A is a histogram showing gray scale property after converted to a gray tone image.

In step S222, the control unit 58 corrects a highlight gray scale of the gray tone image generated in step S220. The correction is performed to omit a part of the highlight gray scale because excessively detailed gray scale is unnecessary for the outline image. FIG. 7C is a tone curve for a highlight gray scale correction. The grayscale value of the gray tone image is converted in accordance with the tone curve shown in FIG. 7C. FIG. 9B is a histogram after correcting a part of the highlight gray scale. In FIG. 9B, a part of the highlight gray scale of the histogram shown in FIG. 9A is omitted.

In step S224, the control unit 58 extracts the outline image from the gray tone image corrected in the highlight gray scale in step S222. Herein, the method for extracting the outline image from the gray tone image is performed, for example, by a known method such as a method for extracting the edge by using a filter.

In step S226, the control unit 58 divides the outline image extracted in step S244 into two gray scales in the state of color data. Herein, as a threshold value when dividing into two gray scales, any value common for all RGB channels may be used. Note that the threshold value may be determined by tuning or the most suitable threshold value for the outline image may be automatically set. By dividing the outline image into two gray scales, there is an effect in that the data amount of the outline image is reduced.

In step S228, the control unit 58 performs conversion of RGB, YCbCr, HLS for the outline image divided into two gray scales in step S226 to correct the HLS of the outline image. The conversion of RGB, YCbCr, HLS is performed by the same method as in step S208 shown in FIG. 4. Further, in order to match the outline image with the background image, the average value of the histogram of each of the H and S of the background image is obtained, and set the average value of H of the background image as the H of the outline image and set the average value of S of the background image as the S of the outline image. The L of the outline image is set slightly lower than the L of the background image in order to slightly emphasize the outline portion.

### Process for Printing Trace Sheet

Next, a process for printing a trace sheet will be described in detail.

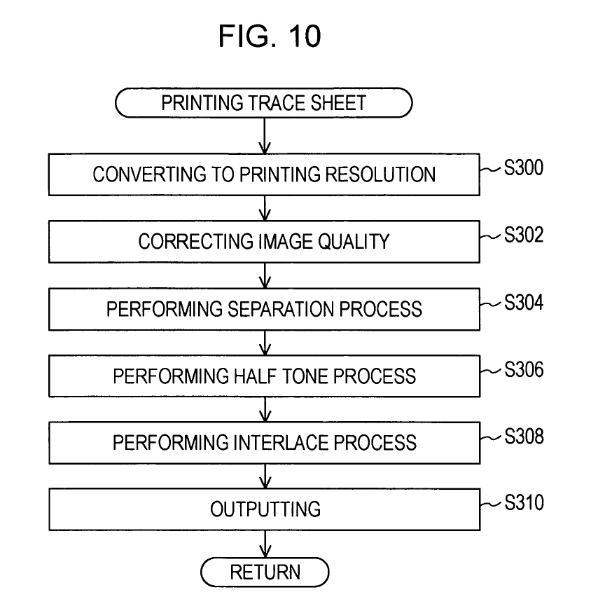

FIG. 10 is a flow chart showing a printing process of a trace sheet. Each process shown in FIG. 10 is performed by the control unit 58 by executing a predetermined module of a control program.

First, in step S300, the control unit 58 converts the resolution of a background image of a trace sheet in combination with the digital image processing portion 66 in accordance with the size of the free drawing area 100 shown in FIG. 11 to which the background image is allocated. Further, the whole image of the trace sheet is converted in accordance with a print resolution.

In step S302, the control unit 58 corrects the image quality of the user image allocated to the sub image area 102 in combination with the digital image processing portion 66. Herein, the control unit 58 performs, for example, unsharp processing or the like.

In step S304, the control unit 58 performs a separation process. Herein, for example, the control unit 58 converts the gray scale value of the trace sheet image from the value of RGB color space to the value of CMY color space (auxiliary cannel of K (black) or the like may be added).

In step S306, the control unit 58 performs a halftone process. The basic of the halftone process is a process for convert the alignment of color values of multiple gray scales into an alignment of two values by which whether an ink drop is ejected or not is determined. When a large, a middle, and a small ink liquids are used in combination, a color value of multiple gray scale is converted to any one of four values of “no ejection”, “ejecting a small ink liquid”, “ejecting a middle ink liquid”, and “ejecting a large ink liquid” for every channel. In this case, the number of gray scale which can be expressed by an ink liquid is four gray scales. This generates an error in the gray scale of each pixel. Many gray scales can be falsely expressed by dispersing the error into the neighborhood pixels. In order to execute such an error dispersing process at a high speed, the four values allocated to the target pixel for every gray scale of CMY and a lookup table in which an error dispread into the neighborhood pixels is written are stored in the ROM 62.

In step S308, the control unit 58 performs interlace process for changing the order of the ejection data of four values formed by the halftone process into an ejection order.

In step S310, the control unit 58 outputs the ejection data to the print control portion 82 in the order of ejection. The print control portion 82 prints a trace sheet by driving the recording head 84 based on the ejection data sequentially stored in the buffer memory.

### Process for Generating Handwritten Outline Image

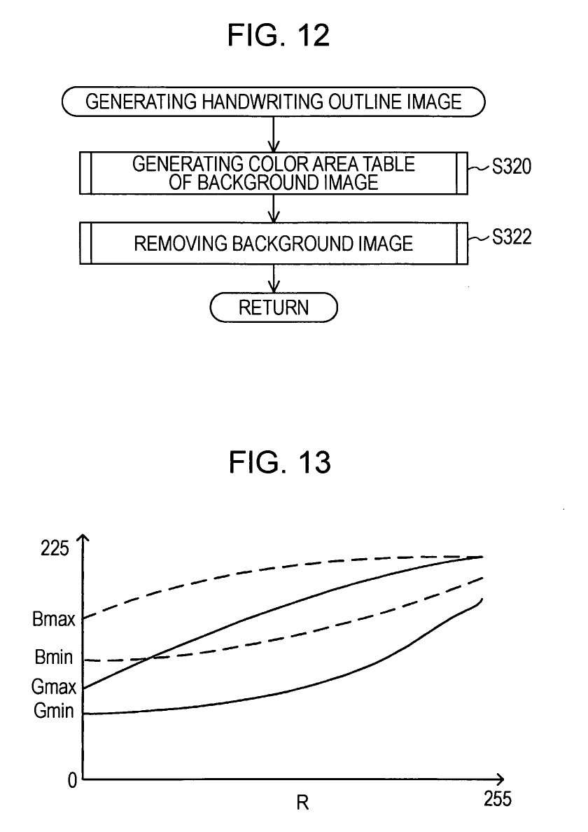

Next, a process for generating a handwritten outline image will be described in detail based on a background image containing a handwritten outline image. A handwritten outline image is generated by separating and extracting a handwritten outline image from a background image containing a handwritten outline image scanned by the scan unit 50. FIG. 12 is a flow chart showing a process for generating a handwritten outline image in detail. As shown in FIG. 12, for the generation of a handwritten outline image, first, a color area table of a background image is generated in step S320. Then, the background image is removed based on the generated color area table to extract the handwritten outline image in step S322.

### Process for Generating Color Area Table of Background Image

A process for generating a color area table of a background image in step S320 will be described. In step S320, the control unit 58 generates a color area table of a background image based on the image of the sample patch 96 contained in the image of the scanned trace sheet. The color area table of the background image is a lookup table in which a color area of the sample patch 96 coincident with the color area of the background image is stored.

FIG. 13 is a graph showing an example of the data stored in a color area table of a background image. In order to precisely recognize the area of the background image in the free drawing area 100, the control unit 58 must perfectively record the color area of the sample patch which matches with the color area of the background image. Consequently, modeling for storing the color area of the sample patch in the RAM 60 whose capacity is limited is required. The sample patch and the background image are the images of cyan, so that the image of the sample patch becomes an image in which the grayscale of R channel is the main. Further, the grayscales of B and G channels have a strong correlation with the grayscale of R channel and have a characteristic in witch the gray scales are changed only in a narrow width. Consequently, the control unit 58 can store the color area of the sample patch and the background image with a small capacity by recording the way how the grays scales of B and G channels are distributed with respect to the gray scale of R channel. To be more specific, the control section 58 can store the color area of the sample patch by searching the values of RGB three channels of the image of the sample patch for every pixel and by detecting the maximum values and the minimum values of G and B channels with respect to the values of any R channel. Hereinafter, a description will be made in detail based on a flow chart.

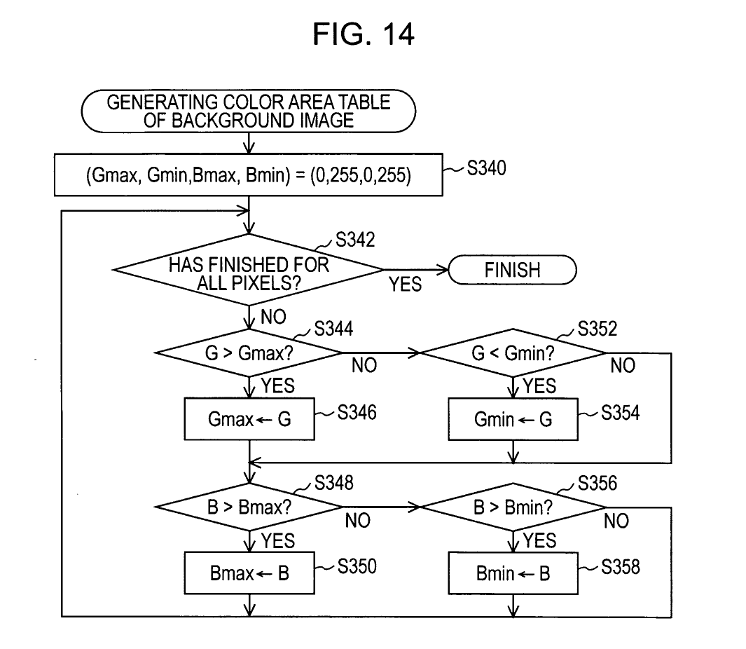

FIG. 14 is a flow chart showing a process for generating a color area table of a background image. In step S340, the control unit 58 resets the minimum values (Gmin, Bmin) and the maximum values (Gmax, Bmax) of G and B channels. Herein, the control unit 58 sets the values of (Gmax, Gmin, Bmax, Bmin) corresponding to all of R values to (0, 255, 0, 255).

In step S342, the control unit 58 judges whether the process described below is finished or not for all pixels of the image of the sample patch and repeats the process described below for all pixels.

In steps S344 and S346, the control unit 58 judges whether the value of G channel of a target pixel is larger or not than the maximum value of G channel (Gmax) stored so as to correspond to the value of R channel of the target pixel. When the value of G channel of the target pixel is larger than Gmax, the maximum value of G channel (Gmax) corresponded to the value of R channel of the target pixel is updated to the value of G channel of the target pixel.

In steps S352 and S354, the control unit 58 judges whether the value of G channel of a target pixel is smaller or not than the minimum value of G channel (Gmin) stored so as to correspond to the value of R channel of the target pixel. When the value of G channel of the target pixel is smaller than Gmin, the minimum value of G channel (Gmin) corresponded to the value of R channel of the target pixel is updated to the value of G channel of the target pixel.

In steps S348 and S350, the control unit 58 judges whether the value of B channel of a target pixel is larger or not than the maximum value of B channel (Bmax) stored so as to correspond to the value of R channel of the target pixel. When the value of B channel of the target pixel is larger than Bmax, the maximum value of B channel (Bmax) corresponded to the value of R channel of the target pixel is updated to the value of B channel of the target pixel.

In steps S356 and S358, the control unit 58 judges whether the value of B channel of a target pixel is smaller or not than the minimum value of B channel (Bmin) stored so as to correspond to the value of R channel of the target pixel. When the value of B channel of the target pixel is smaller than Bmin, the minimum value of B channel (Bmin) corresponded to the value of R channel of the target pixel is updated to the value of B channel of the target pixel.

When the process described above is finished for all pixels, the maximum values and the minimum values of B and G channels are stored for the all values of R channel and the color area of the sample patch is perfectively stored. The data size of a color area table storing the maximum values and minimum values of B and G channels so as to be associated with the value of R channel is only 1K byte (256×2×2 bytes) when the grayscale value of each channel is 1 bite.

### Process for Removing Background Image

Next, a process for removing a background image in step S322 shown in FIG. 12 will be described. In step S322, the control unit 58 separates only a handwritten outline image from a background image containing the handwritten outline image of a trace sheet. Herein, the control unit 58 adds a channel (alpha channel) showing a degree of transparency to the background image containing the handwritten outline image and sets the area of only the background image to a transparent area.

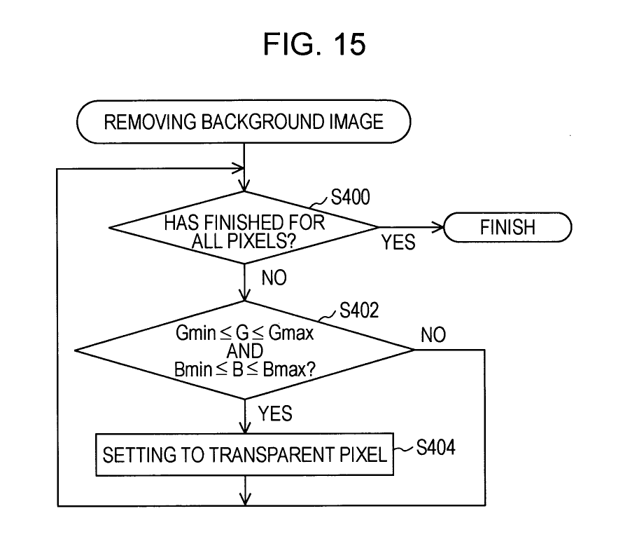

FIG. 15 is a flow chart showing a removing process of a background image.

In step S400, the control unit 58 judges whether the process described below is finished or not for all pixels of an image of the free drawing area 10 contained in a trace sheet and repeats the process described below for all pixels.

In step S402, the control unit 58 judges whether the values of B and G channels of a target pixel is within the range of the values of B and G channels stored in a color area table of a background image so as to correspond to the value of R channel of the target pixel or not. That is, the control unit 58 judges whether or not the maximum value G channel stored so as to correspond to the value of R channel of the target pixel is larger than the value of G channel of the target pixel and the minimum value of G channel stored so as to correspond with the value of R channel of the target pixel is smaller than the value of G channel of the target pixel and the maximum value of B channel stored so as to correspond with the value of R channel of the target pixel is larger than the value of B channel of the target pixel and the minimum value of B channel stored so as to correspond with the value of R channel of the target pixel is smaller than the value of B channel of the target pixel.

When the value of B or G channels of the target pixel is within the range of the value of B or G channel stored in a color area table of a background image so as to correspond to the value of R channel of the target pixel, the color value of the target pixel is within the color area of the background image. Accordingly, the control unit 58 sets the target pixel to a transparent pixel in step S404. That is, the alpha channel of the target pixel is set to the value showing transparency.

When the process described above is finished for all pixels of an image of the free drawing area 100, the area for only a background image is set to a transparent area and an image of only a contour handwritten by the user is generated.

As described above, in the multifunction machine 1 as an image forming system according to the embodiment, by referring a background image of a background image (including outline) printed on a trace sheet as a trace, the user can handwrite a contour or the like on the trace and print the contour or the like on a coloring sheet as a line drawing for coloring. The user can easily create a line drawing for coloring which is desired by the user by faithfully tracing the outline of the image or the like on the trace by using a writing material or the like without being required any skills or the like for operating drawing tools or the like.

Further, the background image printed on a trace sheet is a monotone image whose color area is reduced to an area mainly formed by cyan. Accordingly, the multifunction machine 1 can discriminate the area of a contour or the like handwritten by a hue except cyan on a background image from the area of the background image. Herewith, the user can handwrite on the background image printed on a trace sheet by using a writing material of any hue except cyan. Further, the background image is reduced in shade, so that the multifunction machine 1 can discriminate the area of a contour or the like handwritten by a dark color on a background image from the area of the background image. Herewith, the user can handwrite on a background image by using a writing material of a dark color.

Further, the user can record and store the image data expressing an outline image printed on a coloring sheet in the memory 61, so that the user can read out a line drawing for coloring made by the user from the memory 61 and print the line drawing as many times as needed. Herein, the image data stored in the multifunction machine 1 may be vector data generated by vectorizing the image data. Vectoring of the image data enables to output a smooth line drawing even when the line drawing is laid out on any size of a recording medium. Further, vector data requires a data capacity smaller than that of bitmap data, so that the process speed for treating the data can be increased.

Further, the multifunction machine 1 generates an outline image based on a background image and prints a trace sheet on which the background image (including outline) in which the outline image is overlapped with the background image is traced. The user can trace an outline or the like by referring the outline image overlapped with the background image when handwriting a contour or the like on the trace, so that the user can easily perform the handwriting operation of a contour or the like.

Further, the hue and saturation of the outline image overlapped with the background image are approximately the same as the hue and saturation of the background image, so that the outline image enables to naturally show the outline portion of the background image without uncomfortable feeling. Further, the luminosity of the outline image is set lower than the average of the luminosity of the background image, so that the outline image can accentuate the outline portion of the background image and show the outline in a clear manner.

Further, the multifunction machine 1 receives a selection for three type of printing method of “coloring printing”, “trace sheet printing”, and “trace (including outline) sheet printing”. When “coloring printing” is selected, the multifunction machine 1 receives shifting to printing of the outline image in the state where the generated outline image is displayed on the screen. The user can perform printing while confirming the outline image to be a line drawing for coloring, so that missing of printing an improper image or the like can be prevented and operational performance is also improved.

Further, after a background image or a background image (including outline) is printed on a trace sheet, the multifunction machine 1 continuously displays an instruction screen for requiring setting of a trace sheet and receives starting of scanning operation without receiving menu operation or the like. After a trace sheet is printed, the user generally handwrites a contour or the like on the printed trace sheet and instructs starting of scanning operation without change. Accordingly, there is no waste in operation and operational performance is also improved.

In the embodiment describe above, a contour or the like handwritten by the user on a background image printed on a trace sheet is extracted and the handwritten contour or the like is printed on a coloring sheet as a line drawing for coloring. However, the application of the invention is not limited to the coloring sheet and can be applied to another application. For example the user may handwrite an illustration image, a drawing image, or the like instead of a line drawing for coloring and print the illustration image, the drawing image, or the like by extracting it from the background image. The user can handwrite an illustration image, a drawing image, or the like on the background image, so that a painting in which an original image is more precisely and faithfully drawn can be easily obtained.

What is claimed is:

1. An image printing method, comprising:
obtaining an image;
reducing a color area of the obtained image and generating a color area reduced image;
extracting a contour from the obtained image and generating an outline image;
generating a first image by overlapping the outline image with the color area reduced image;
printing the first image on a recording medium;
scanning an image containing an object recorded by a user on the recording medium on which the first image is printed;
generating a second image by extracting the object recorded by the user based on the scanned image; and
printing the second image on a recording medium.

2. The image printing method according to claim 1, wherein the hue and the saturation of the outline image are respectively approximately the same as the average of the hue of the color area reduced image and the average of the saturation of the color area reduced image.

3. The image printing method according to claim 1, wherein the luminosity of the outline image is lower than the average luminosity of the color area reduced image.

4. The image printing method according to claim 1, further comprising
receiving an instruction by which the image printed on the recording medium is selected from among the outline image, the color area reduced image, and the overlapped image of the color area reduced image and the outline image, and wherein the selected image is printed as the first image.

5. The image printing method according to claim 4, further comprising displaying the outline image, and wherein when receiving the instruction, the selection of whether the outline image is printed on the recording medium or not is made in the state where the outline image is displayed.

6. An image printing method, comprising:
obtaining an image;
reducing a color area of the obtained image and generating a color area reduced image;
extracting a contour from the obtained image and generating an outline image;
generating a first image by overlapping the outline image with the color area reduced image;
printing the first image on a recording medium;
scanning an image containing an object recorded by a user on the recording medium on which the first image is printed;
generating a second image by extracting the object recorded by the user based on the scanned image;
storing image data expressing the second image; and
printing the second image on a recording medium.

7. The image printing method according to claim 6, wherein, the image data expressing the second image is stored as vectorized vector data.

8. An image forming system, comprising:
an image obtaining portion for obtaining an image;
a color area reduced image generating portion for generating a color area reduced image from the obtained image;
an outline image generating portion for generating an outline image by extracting a contour form the obtained image;
a first image generating portion for generating a first image by overlapping the outline image with the color area reduced image;
a first image printing portion for printing the first image on a recording medium;
a scanning portion for scanning an image containing an object written by a user on the recording medium on which the first image is printed;
a second image generating portion for generating a second image by extracting the object recorded by the user based on the scanned image scanned by the scanning portion; and
a second printing portion for forming the second image on a recording medium.
